(19) United States
(12) Patent Application Publication
(10) Pub. No.: US 2018/0208207 A1
(43) Pub. Date: Jul. 26, 2018

(54) PERSONALIZED USER EXPERIENCE DELIVERY

(71) Applicant: Microsoft Technology Licensing, LLC, Redmond, WA (US)

(72) Inventors: Neal T. Osotio, Sammamish, WA (US); Angela L. Moulden, Ravensdale, WA (US)

(21) Appl. No.: 15/413,885

(22) Filed: Jan. 24, 2017

(51) Int. Cl. B60W 40/09; B60W 40/04; G01S 19/13; B60R 16/037; G05D 1/00; B60W 30/182; B60W 50/10

(52) U.S. Cl. CPC B60W 40/09; B60W 40/04; G01S 19/13; B60W 50/10; G05D 1/0061; G05D 1/0088; B60W 30/182; B60R 16/037

(57) ABSTRACT

A user experience system discloses determining, using graphical positioning system (GPS) parameters, a geo-physical location of a vehicle, determining a traffic pattern encountered by the vehicle based in the geo-physical location of the vehicle, determining a value of user distraction level for a user in the vehicle, and changing presentation of user experience to the user based on the value of the user distraction level. In an alternative implementation, the vehicle is a semi-autonomous vehicle and determining the user distraction level for the user further comprises determining an amount of active driving of the semi-autonomous vehicle required of the user.

### BACKGROUND

Vehicles operating in an autonomous (e.g., driverless) mode can relieve occupants, especially the driver, from some driving-related responsibilities. When operating in an autonomous mode, the vehicle can navigate to various locations using on-board sensors, allowing the vehicle to travel with minimal human interaction or in some cases without any passengers. Therefore, autonomous vehicles give passengers, especially the person who would otherwise be driving the vehicle, the opportunity to do other things while travelling. Instead of concentrating on numerous driving-related responsibilities, the driver may be free to watch movies or other media content, converse with other passengers, read, work on one or more projects, etc., while riding in an autonomous vehicle.

### SUMMARY

Implementations described herein disclose a method for providing personalization in a driverless environment. An implementation of the method includes determining, using graphical positioning system (GPS) parameters, a geo-physical location of a vehicle, determining a traffic pattern encountered by the vehicle based in the geo-physical location of the vehicle, determining a value of user distraction level for a user in the vehicle based on the traffic pattern encountered by the vehicle, and changing presentation of user experience to the user based on the value of the user distraction level. In an alternative implementation, the vehicle is a semi-autonomous vehicle and determining the user distraction level for the user further comprises determining an amount of active driving of the semi-autonomous vehicle required of the user.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

A further understanding of the nature and advantages of the present technology may be realized by reference to the figures, which are described in the remaining portion of the specification. In the figures, like reference numerals are used throughout several figures to refer to similar components.

FIG. 1 illustrates an example implementation of a system for providing latency and distraction level based personalization of user experience.

FIG. 2 illustrates an example block diagram of components of a system for providing latency and distraction level based personalization of user experience.

FIG. 3 illustrates an example user environment in a driverless car providing latency and distraction level based personalization of user experience.

FIG. 4 illustrates example operations for providing latency and distraction level based personalization of user experience.

FIG. 5 illustrates an example system that may be useful in implementing the described technology for providing latency and distraction level based personalization of user experience.

FIG. 6 illustrates an example mobile device that may be useful in implementing the described technology for providing latency and distraction level based personalization of user experience.

### DETAILED DESCRIPTIONS

A personalized user experience delivery system disclosed herein allows changing user experience delivered to a user in an autonomous or semi-autonomous vehicle based on latency of the vehicle to a destination and/or distraction level of the user in the vehicle.

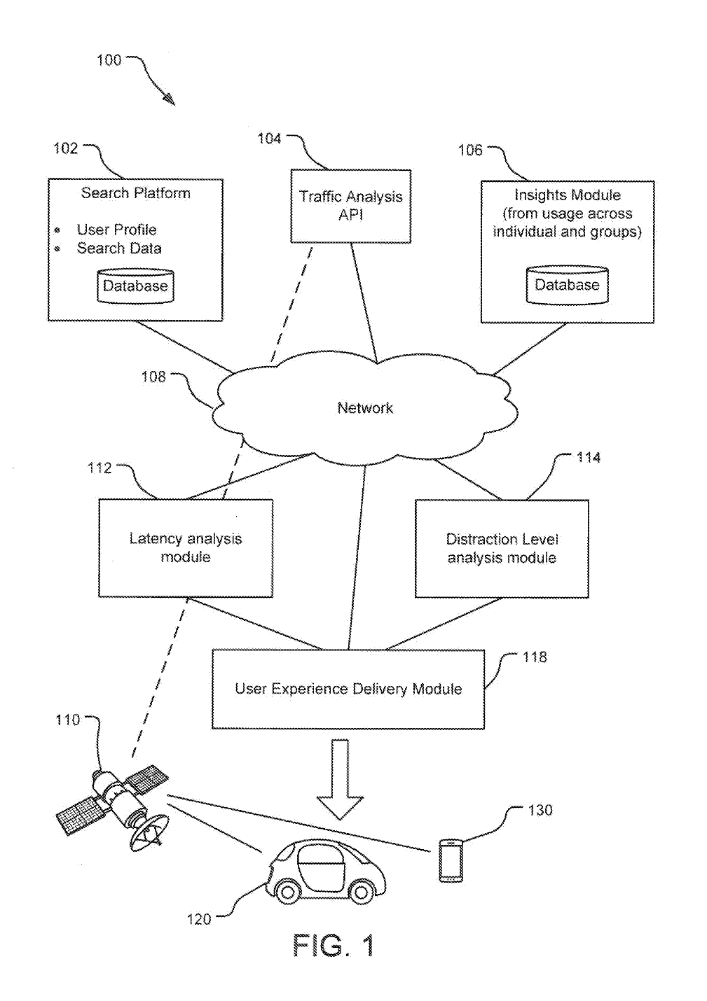

FIG. 1 illustrates an example implementation of a personalized user experience delivery system 100 for providing latency and distraction level based personalization of user experience. The personalized user experience delivery system 100 provides personalized user experience to one or more users in a vehicle 120 during a commute. For example, the personalized user experience delivery system 100 may deliver entertainment user experience, productivity user experience, family user experience, etc., during such commute and change such user experience based on latency of the vehicle during the commute or a level of user distraction at various points during the commute.

The personalized user experience delivery system 100 may communicate with various information sources via a network 108. For example, such network 108 may be the Internet. One such source of information may be a search platform 102 that searches various databases, such as user profile database, search database, etc., to retrieve user experience data for the user in the vehicle 120. For example, the search platform 102 may search a social network database to determine entertainment experience preferences of the user. Alternatively, the search platform 102 may search a user's emails to determine one or more productivity experience that is appropriate for the user. As an example, by searching the user's emails, calendar, etc., the search platform 102 may determine that during a commute by the user in the vehicle 120 on a given day, the user needs to prepare a power point presentation for a meeting later that day.

A traffic analysis application programming interface (API) 104 may gather various traffic related information to determine and update total time to destination for the vehicle 120 during a commute. The traffic analysis API 104 may interact with various internet of things (iOT) sensors of the vehicle 120, one or more apps on a mobile device 130 of the user on the vehicle 120, a geographic positioning system (GPS) satellite 110, etc., to gather information about traffic and location of the vehicle 120 to determine the total time to commute. Furthermore, the traffic analysis API 104 may also gather information from other data sources such as news sources, etc., to collect information about weather, accidents, etc., and use this information to determine the total time to destination.

An insights module 106 may collect information from various users in the vehicle 120 to determine user preferences based on interactions of the users. For example, if a user receives a text message about an emergency during the commute and if the insights module 106 has access to such text information, the content of the text message may be analyzed to determine delivery of user experience. As another example, if a user of the vehicle 120 receives a calendar request for a meeting, the subject matter of the meeting may be an input used to determine presentation of a productivity experience and a spreadsheet related to the meeting may be presented as part of the productivity experience.

A latency analysis module 112 gathers one or more of the information from the search platform 102, the traffic analysis API 104, the insights module 106, etc., and determines latency of the vehicle 120 during the commute. As used herein, the term “latency” may be used to refer to various time periods during the commute, such as the total time to destination, the time to destination at any given point, a time to an intermediate stop by the vehicle 120, a time to an intermediate event—such as an upcoming accident site, etc. The latency analysis module 112 may be implemented using various algorithms, computer instructions, machine learning instructions, etc., that analyze the various inputs to determine one or more latency values.

A distraction level analysis module 114 receives inputs from the search platform 102, the traffic analysis API 104, the insights module 106, from the mobile device 130 of the user, from the latency analysis module 112, etc. The distraction level analysis module 114 may determine the level of distraction of the user where the level of distraction may be determined based on various factors such as the time the user has to spend in driving the vehicle, the time the user needs to respond to an urgent incoming email, the emotional level of the user, one or more accidents along the commute, etc. For example, if the commute is mostly over highways with less numbers of turns, exits, etc., the distraction level of the user may be determined to be lower than if the commute involved city streets with a number of turns, traffic lights, etc.

In one implementation, the distraction level analysis module 114 may also store various distraction threshold levels associates with various user experiences. In one implementation, the distraction level of a user may be calibrated over a scale of zero to one hundred with zero being low distraction level and one hundred being a high distraction level. In such a case, a distraction threshold of twenty may be set for a productivity user experience so that if the determined value of the user is above twenty, the user is not presented with any productivity user experience. Yet alternatively, even various types of productivity experiences may be associated with various distraction thresholds. With low importance productivity experience, such as email correspondence, being associated with a lower distraction threshold and high importance productivity experience, such as software coding, being associated with a higher distraction threshold.

A user experience delivery module 118 may take the latency values determined by the latency analysis module 112 and the distraction levels and thresholds determined by the distraction level analysis module 114 to determine appropriate user experience to be presented to the users in the vehicle 120. For example, when a user starts a commute, the user experience delivery module 118 may select various TV shows with a length of time such that the user will be able to complete any of these shows before the commute ends without leaving additional idle time for the user and give an option to the user to select one of such TV shows. Alternatively, the user experience delivery module 118 may select a productivity experience such as preparing a presentation where the estimated time for the presentation is generally in line with the commute time. Similarly, the user experience delivery module 118 may select a productivity user experience based on the expected distraction level for a user during the commute. Thus, if the commute is supposed be on city streets where it is expected that the user will have to drive the semi-autonomous vehicle for various periods, the user experience delivery module 118 may decide that preparing a presentation is not an appropriate user experience.

In one example implementation, the user experience delivery module 118 may also change the user experience based on new information received from the latency analysis module 112 and the distraction level analysis module 114. As an example of the working of the personalized user experience delivery system 100, a user, James, may be in route in the vehicle 120 to home after leaving his office. When he gets into his vehicle 120, the personalized user experience delivery system 100 may determine that James' commute home will be long as it's raining. Specifically, the personalized user experience delivery system 100 may determine this based on information gathered from the insights module 106. In this case, James is presented with both entertainment and productivity experiences in his autonomous vehicle that suit the projected longer commute time.

In one example, James chooses to interact with a 3D gaming experience to relax after a long day at work. Specifically, using HoloLens, James is able to play a logic game with his son who is currently at home. Ten minutes into the commute, the audio and visual sensors of the vehicle 120 may pick up on both audio and visual cues that there is an accident ahead. For example, the sensors of the vehicle 120 may pick up such signals via audio sensor recognition as well as visual matching of a firetruck/ambulance. Output from these sensors are input to latency analysis module 112 and the distraction level analysis module 114 of the personalized user experience delivery system 100.

The distraction level analysis module 114 dynamically adjusts the distraction level for James and if it becomes higher than the distraction threshold appropriate for the logic game, James' game is automatically put on hold as he re-takes full control of the vehicle 120 to drive on the shoulder. After passing the accident, the distraction level analysis module 114 reduces James' distraction level and once it is below the appropriate threshold for the logic game, the personalized user experience delivery system 100 presents James with the logic game experience with his son.

In one implementation of the personalized user experience delivery system 100, based on James' data, all other vehicles along his route are updated to pivot the distraction level of their users based on the overall time necessary to pass the accident. This may result in change in user experience of other users in the vehicles near the site of the accident to ensure that these vehicles and their drivers are prepared to pass the accident safely.

As another example implementation of the personalized user experience delivery system 100, James may be commuting home in the vehicle 120 over a weekend after watching a football game. Based on information collected from James' social graph, the user experience delivery module 118 may preset James with entertainment experience in form of fantasy football stats while the vehicle 120 is autonomously driving. At some point during the commute, the personalized user experience deliver system 100 may recognize that his wife has called and she needs a few more items at the grocery store to complete her dinner recipe. Based on the initiation of the call on the mobile device 130, the personalized user experience delivery system 100 may temporarily halt delivery of the fantasy football user experience or fade it into the background and initiate a voice recognition application. The distraction level analysis module 114 may also increase the distraction level in response to the incoming call so as to allow James to focus on the call.

Based on analysis of the phone conversation, a mapping application may update the route to stop at a grocery store prior to going home. Additionally, James' phone and in-car user experiences are updated to show the updated shopping list. Furthermore, the latency analysis module 112 may also update the latency and the user experience delivery module 118 may update the user experience based on the updated latency and distraction levels. For example, the user experience may be updated back to the fantasy football with additional information provided to James for his review in view of the increased latency because of the detour to the grocery store.

As another example of the personalized user experience delivered by the personalized user experience delivery system 100, a user, Bill, who works for a software company may be using the vehicle 120 to go to work. The personalized user experience delivery system 100 operates the vehicle 120 in work productivity mode so that on Bill's commute, he can do a bit of work to get ready for his busy day. The personalized user experience delivery system 100 adjusts the interior lighting, sound, visual displays and secondary devices that are with Bill and in the vehicle 120, accordingly for higher efficiency for Bill.

Each day, Bill also takes his son Jeromy and drops him off at his school. Jeromy, has autism and other special needs. Based on Jeromy's data graph, his use of automated personal assistant, and other products, the personalized user experience delivery system 100 is aware that Jeromy has special needs and therefore the user experience delivered to Bill during the commute needs to account for potential added distraction level for Bill.

For example, on a given morning before getting ready for the commute, Bill notices that Jeromy is a bit agitated and more difficult than his usual self. He sensed that today could be a difficult day for Jeromy. The first half of their commute goes well and therefore, the personalized user experience delivery system 100 provides the productivity experience to Bill as usual. As the commute progresses, the vehicle 120 hits some slow traffic that changes their regular time to commute pattern. Because of Jeromy's autistic characteristics, any change in his regular routine can induce a strong emotional and physical reaction. The personalized user experience delivery system 100 is aware of this and as the commute pattern changes, the distraction level analysis module 114 adjusts the distraction level of Bill. Furthermore, as other drivers become more impatient in view of the increased traffic, out of frustration, they begin to honk their horns. The personalized user experience delivery system 100 picks up such additional noise from one or more iOT devices associated with the vehicle 120 and this information is again used by the distraction level analysis module 114 to adjust Bill's distraction level.

In response to the increased distraction level, the personalized user experience delivery system 100 changes the user experience presented to Bill. For example, the personalized user experience delivery system 100 switches the interior of the car dynamically by dimming the lights, turning on music that is soothing for Jeromy, changes the vehicle's 120 ride characteristic to a more soothing mode by increasing hydraulics, reducing number of lane changes, etc. The personalized user experience delivery system 100 also turns off the productivity experience for Bill so that he can attend to Jeromy's needs.

In yet another alternative example of the personalized user experience delivery system 100, Toni, a mother of two, gets her kids in the vehicle 120 and is on her way to a grocery store. On the way to the grocery store, the personalized user experience delivery system 100 of the vehicle 120 knows that Toni is still in her task workflow to pick up groceries and provides a task flow user experience so that she can continue to revise her grocery list. Because the vehicle 120 is in semi-autonomous mode, Toni has control of the vehicle 120 during this trip. Along the way, Alyssa, Toni's young daughter spills her cup of apple juice all over herself in the back seat of their vehicle 120.

The personalized user experience delivery system 100 senses this in the form of input from one or more audio-visual sensors of the vehicle. In response, the distraction level analysis module 114 increases the distraction level of Toni. The user experience delivery module 118 determines that Toni is not able to give any attention to driving the vehicle and therefore, switches the car to autonomous mode from the semi-autonomous mode. Furthermore, the user experience delivery module 118 interrupts the current task workflow (creating a grocery list) to one tailored more to the immediate situation so that Toni can attend to the safety of the vehicle 120 and her daughter. For example, the user experience delivery module 118 proactively provides Toni with the nearby location (gas station, local Starbucks, etc.) for her to stop. Once Toni accepts such nearby location, the user experience delivery module 118 commands the vehicle 120 to drive to such nearby location.

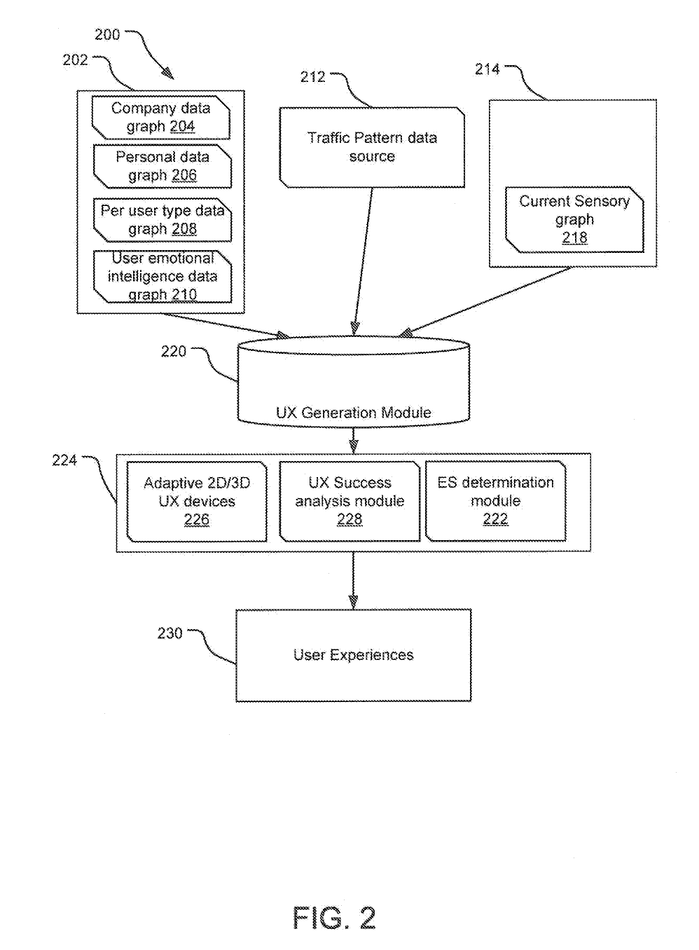

FIG. 2 illustrates an example block diagram of components of a user experience delivery system 200 (referred to as the “UX system”) for providing latency and distraction level based personalization of user experience in a vehicle. An implementation of the UX system 200 collects data from a user data source 202, from a traffic pattern data source 212, and from a sensor data source 214. For example, the user data source 202 may provide various types of data graphs about a user, such as a company data graph 204, a personal data graph 206, per user type data graph 208, and a user's emotional intelligence data graph 210. The sensor data source 214 may provide current sensory graph 218 including data collected by various sensors in and around a vehicle using the UX delivery system 200.

A UX generation module 220 collects the data from these various sources and performs real time analysis of the graphs to produce an individual user based experience. For example, the UX generation module 220 may analyze data from the personal data graph 206 to determine the type of entertainment preferred by a user, analyze data from the traffic pattern data source 212 to determine a latency time, analyze data from the current sensory graph 218 to determine if the user's distraction level is to be changed, and determine the entertainment user experience to be presented to the user in an autonomous or a semi-autonomous vehicle.

A user experience presentation module 224 delivers a user experience generated by the UX generation module 220 using adaptive 2D/3D UX devices 226, such as HoloLens, etc., in an autonomous or a semi-autonomous vehicle. A UX success analysis module 228 iteratively measures and analyzes success of the UX delivered to the user. Thus, various types of user experiences 230, such as productivity user experience, entertainment user experience, etc., may be achieved by the user within an autonomous or a semi-autonomous vehicle.

As the distraction level of users in the vehicle changes, the emotional state (ES) and behavior of the user's in the vehicle also changes. Specifically, the change in a user's behavior may depend on the emotional intelligence (EI) and/or emotional quotient (EQ) of the user. The ES of a user in the vehicle may be determined using data collected by a wide variety of devices, such as a watch worn by a user, a sensor measuring skin temperature of the user, a sensor measuring movements of the user in the vehicle, etc. Some of such ES data may also depend on past behavior of the user, current events in the social network of the user, etc.

An ES determination module 222 collects data from various sources including devices on and around the user and the vehicle, the user emotional intelligence data graph 210, the personal data graph 206, etc., and determines the ES of the user. For example, such ES may be quantified on a one-dimensional scale, such as scale of one to one-hundred, with higher values indicating more agitated emotional state. Alternatively, a multi-dimensional scale may also be used for quantifying the ES. The user experience presentation module 224 may also take such quantified value of ES into consideration in presenting or changing the user experiences 230.

As an example of changing user experiences 230 based on ES of a user, James and his team may be working on an important presentation (work productivity) to leadership that is due later in a day. Specifically, James' team may be working in a building off the Main Campus where the presentation will happen and they may decide to commute together to finish a few details on their presentation. As they all pile into James' vehicle (autonomous/semi-autonomous) and start heading over to the Main Campus, the user experience presentation module 224 presents their presentation on the vehicle display for the team to continue their collaboration on the presentation.

As long as their journey is going well, the vehicle drives in a normal mode and James' team makes the needed updates on their presentation content. As the vehicle gets closer to the city, the route it is taking may be going through a section where new road construction may be happening. As the vehicle drives though the section of construction the noise level and outside view (construction vehicles and workers, other cars that need to slow down, etc.) the user distraction level increases. As a result, James, in particular, begins to get tense, stressed. The level of James' ES may be determined by the ES determination module 222. Based on this change in James' ES, the user experience presentation module 224 responds by reducing the level of light inside the vehicle. Specifically, the decision to reduce the light may be made based on data from the user emotional intelligence data graph 210, data from the personal data graph 206, etc. Similarly, the user experience presentation module 224 may also activate noise dampening and hydraulics equipment of the vehicle. Such changes in the user experience allows James and his team to continue their editing of their presentation in a more focused and efficient manner.

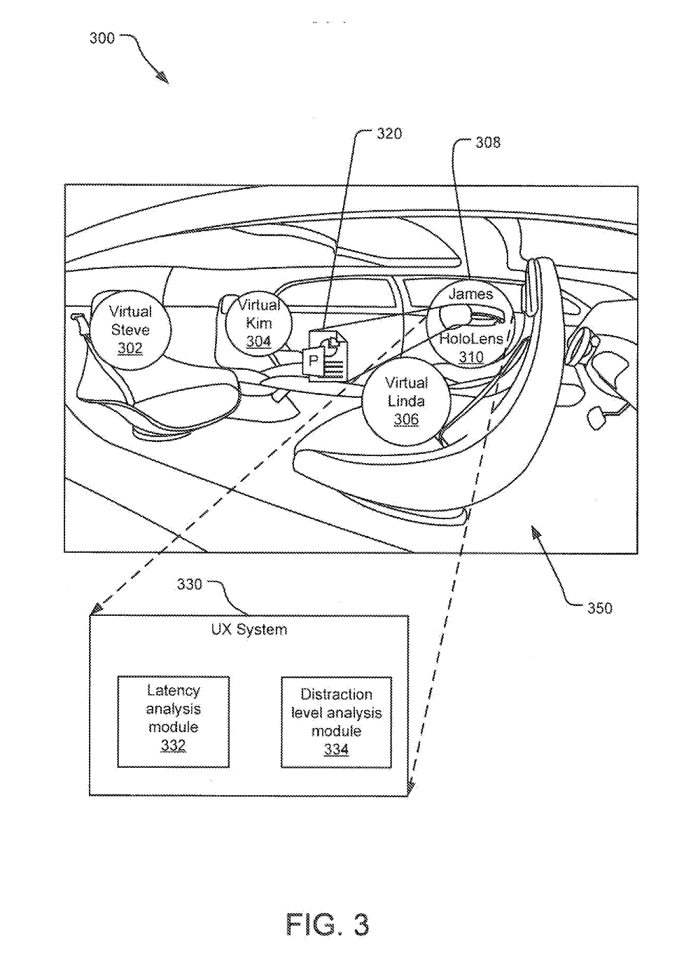

FIG. 3 illustrates an example user environment 300 in an autonomous or a semi-autonomous vehicle 350 providing latency and distraction level based personalization of user experience. Specifically, the user environment 300 includes virtual users Steve 302, Kim 304, and Linda 306 that may participate in a productivity user experience 320, as projected by a HoloLens 310 of a user James 308. For example, the productivity user experience 320 may be generating, revising, or discussing a presentation. The HoloLens 310 may receive one or more inputs regarding selection and/or changes to the productivity user experience 320 based a UX system 330 including a latency analysis module 332 and a distraction level analysis module 334.

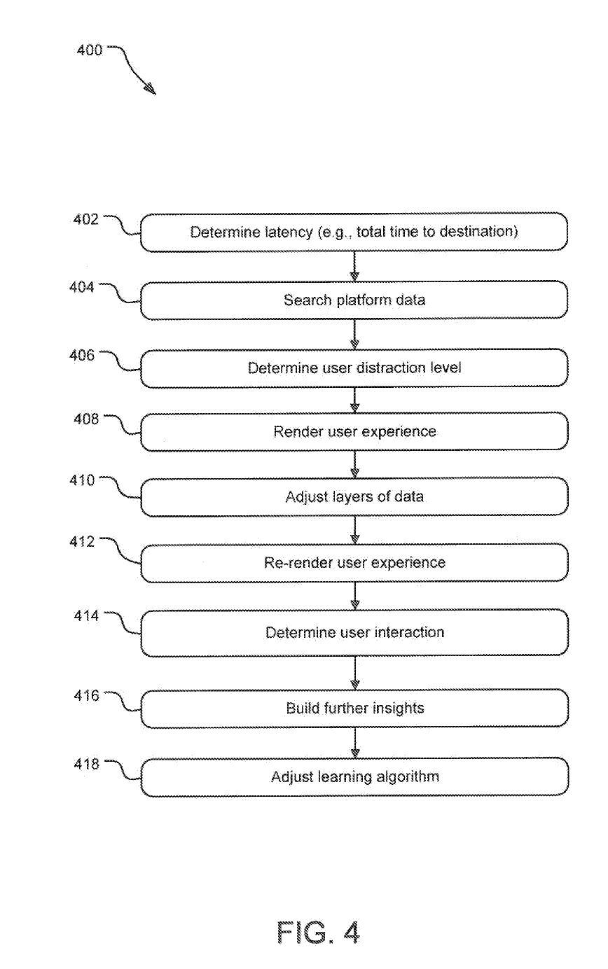

FIG. 4 illustrates example operations 400 for providing latency and user distraction level based personalization of user experience. An operation 402 determines latency time for a vehicle. For example, such latency time may be the total time to destination. An operation 404 searches various platform data, such as user graph, company graph, etc. An operation 406 determines user distraction level for one or more users within the vehicle. An operation 408 renders user experience based on the latency and the user distraction level.

An operation 410 adjusts layers of data used to determine the user experience and based on the updated data, an operation 412 re-renders the user experience. Various user interaction data may be determined and collected by an operation 414 where such data may be used by an operation 416 to build further insights into providing future user experience in the vehicle. A learning algorithm for determining user experiences in vehicles may be adjusted based on the insights by an operation 418.

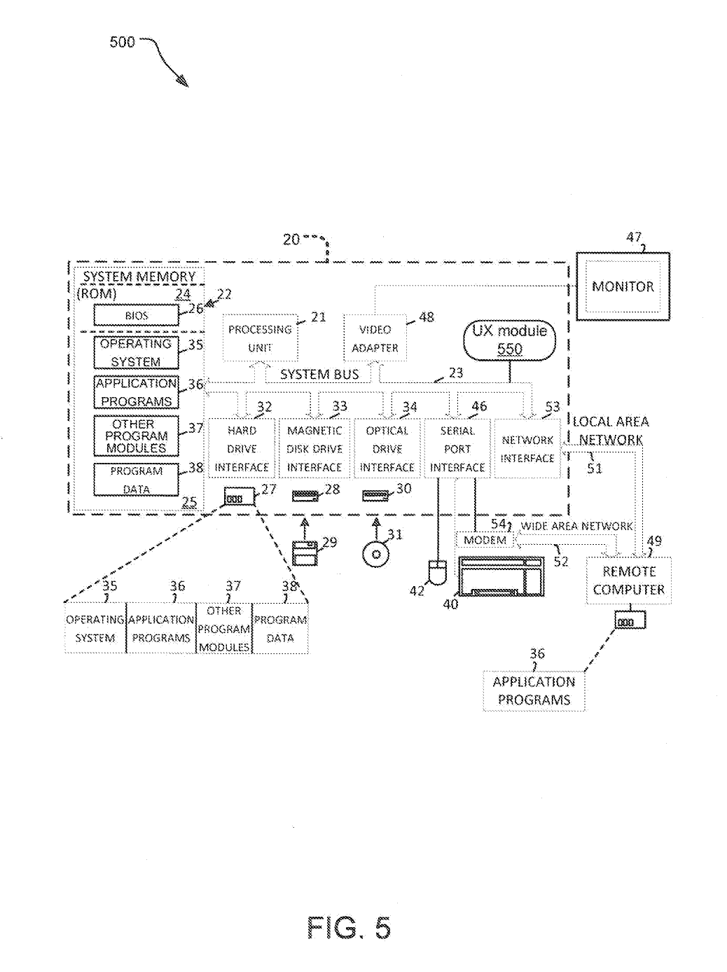

FIG. 5 illustrates an example system 500 that may be useful in implementing the image rendition system disclosed herein. The example hardware and operating environment of FIG. 5 for implementing the described technology includes a computing device, such as a general-purpose computing device in the form of a computer 20, a mobile telephone, a personal data assistant (PDA), a tablet, smart watch, gaming remote, or other type of computing device. In the implementation of FIG. 5, for example, the computer 20 includes a processing unit 21, a system memory 22, and a system bus 23 that operatively couples various system components including the system memory to the processing unit 21. There may be only one or there may be more than one processing unit 21, such that the processor of a computer 20 comprises a single central-processing unit (CPU), or a plurality of processing units, commonly referred to as a parallel processing environment. The computer 20 may be a conventional computer, a distributed computer, or any other type of computer; the implementations are not so limited.

In the example implementation of the computing system 500, the computer 20 also includes an image rendition module 510 providing one or more functions of the image rendition operations disclosed herein. The system bus 23 may be any of several types of bus structures including a memory bus or memory controller, a peripheral bus, a switched fabric, point-to-point connections, and a local bus using any of a variety of bus architectures. The system memory may also be referred to as simply the memory, and includes read-only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The computer 20 may be used to implement a signal sampling module configured to generate sampled signals based on the reflected modulated signal 72 as illustrated in FIG. 1. In one implementation, a frequency unwrapping module including instructions to unwrap frequencies based on the sampled reflected modulations signals may be stored in memory of the computer 20, such as the read-only memory (ROM) 24 and random access memory (RAM) 25, etc.

Furthermore, instructions stored on the memory of the computer 20 may be used by a system for delivering personalized user experience. Similarly, instructions stored on the memory of the computer 20 may also be used to implement one or more operations of a personalized user experience delivery system disclosed herein.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated tangible computer-readable media provide nonvolatile storage of computer-readable instructions, data structures, program modules and other data for the computer 20. It should be appreciated by those skilled in the art that any type of tangible computer-readable media may be used in the example operating environment.

A number of program modules may be stored on the hard disk, magnetic disk 29, optical disk 31, ROM 24, or RAM 25, including an operating system 35, one or more application programs 36, other program modules 37, and program data 38. A user may generate reminders on the personal computer 20 through input devices such as a keyboard 40 and pointing device 42. Other input devices (not shown) may include a microphone (e.g., for voice input), a camera (e.g., for a natural user interface (NUI)), a joystick, a game pad, a satellite dish, a scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the implementations are not limited to a particular type of communications device. The remote computer 49 may be another computer, a server, a router, a network PC, a client, a peer device or other common network node, and typically includes many or all of the elements described above relative to the computer 20. The logical connections depicted in FIG. 5 include a local-area network (LAN) 51 and a wide-area network (WAN) 52. Such networking environments are commonplace in office networks, enterprise-wide computer networks, intranets and the Internet, which are all types of networks.

When used in a LAN-networking environment, the computer 20 is connected to the local area network 51 through a network interface or adapter 53, which is one type of communications device. When used in a WAN-networking environment, the computer 20 typically includes a modem 54, a network adapter, a type of communications device, or any other type of communications device for establishing communications over the wide area network 52. The modem 54, which may be internal or external, is connected to the system bus 23 via the serial port interface 46. In a networked environment, program engines depicted relative to the personal computer 20, or portions thereof, may be stored in the remote memory storage device. It is appreciated that the network connections shown are example and other means of communications devices for establishing a communications link between the computers may be used.

In an example implementation, software or firmware instructions for requesting, processing, and rendering mapping data may be stored in system memory 22 and/or storage devices 29 or 31 and processed by the processing unit 21. Mapping data and/or layer prioritization scheme data may be stored in system memory 22 and/or storage devices 29 or 31 as persistent data-stores. A UX module 550 communicatively connected with the processing unit 21 and the memory 22 may enable one or more of the capabilities of the personalized user experience delivery system disclosed herein.

In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

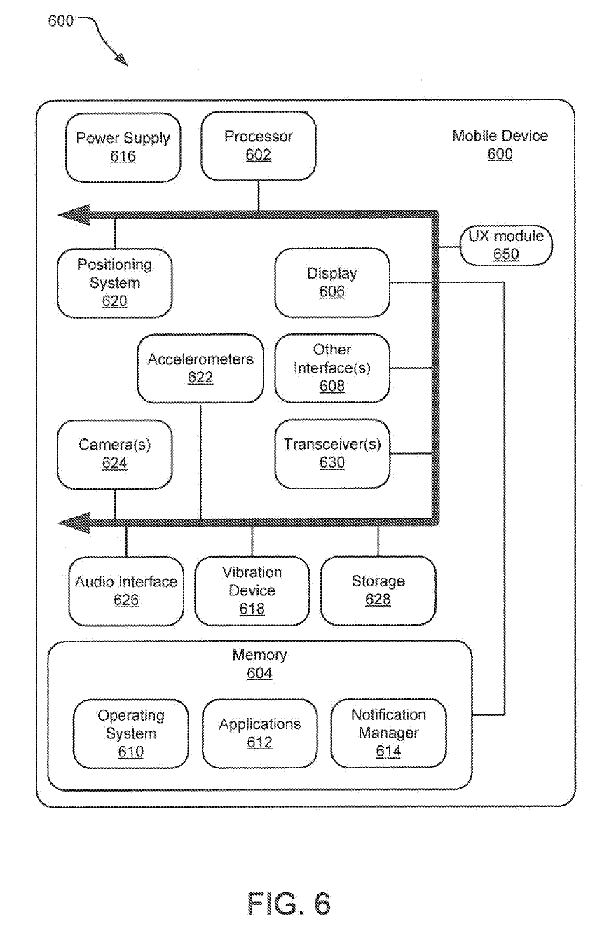

FIG. 6 illustrates another example system (labeled as a mobile device 600) that may be useful in implementing the described technology. The mobile device 600 includes a processor 602, a memory 604, a display 606 (e.g., a touchscreen display), and other interfaces 608 (e.g., a keyboard). The memory 604 generally includes both volatile memory (e.g., RAM) and non-volatile memory (e.g., flash memory). An operating system 610, such as the Microsoft Windows® Phone operating system, resides in the memory 604 and is executed by the processor 602, although it should be understood that other operating systems may be employed.

One or more application programs 612 are loaded in the memory 604 and executed on the operating system 610 by the processor 602. Examples of applications 612 include without limitation email programs, scheduling programs, personal information managers, Internet browsing programs, multimedia player applications, etc. A notification manager 614 is also loaded in the memory 604 and is executed by the processor 602 to present notifications to the user. For example, when a promotion is triggered and presented to the shopper, the notification manager 614 can cause the mobile device 600 to beep or vibrate (via the vibration device 618) and display the promotion on the display 606.

The mobile device 600 includes a power supply 616, which is powered by one or more batteries or other power sources and which provides power to other components of the mobile device 600. The power supply 616 may also be connected to an external power source that overrides or recharges the built-in batteries or other power sources.

The mobile device 600 includes one or more communication transceivers 630 to provide network connectivity (e.g., mobile phone network, Wi-Fi®, BlueTooth®). The mobile device 600 also includes various other components, such as a positioning system 620 (e.g., a global positioning satellite transceiver), one or more accelerometers 622, one or more cameras 624, an audio interface 626 (e.g., a microphone, an audio amplifier and speaker and/or audio jack), and additional storage 628. Other configurations may also be employed.

In an example implementation, a mobile operating system, various applications, and other modules and services may be embodied by instructions stored in memory 604 and/or storage devices 628 and processed by the processing unit 602. User preferences, service options, and other data may be stored in memory 604 and/or storage devices 628 as persistent datastores. A UX module 650 communicatively connected with the processor 602 and the memory 604 may enable one or more of the capabilities of the personalized user experience delivery system disclosed herein.

The personalized user experience delivery system disclosed herein provides solution to a technological problem necessitated by user experience needs in driverless vehicles with changing latency and user distraction levels. Specifically, the personalized user experience delivery system disclosed herein provides an unconventional technical solution to this technological problem by adjusting a user experience in response to changes in latency of an autonomous or a semi-autonomous vehicle.

An implementation of a personalized user experience delivery system disclosed herein provides a method of providing personalization in a driverless environment, the method including determining, using graphical positioning system (GPS) parameters, a geo-physical location of a vehicle, determining a traffic pattern encountered by the vehicle based on the geo-physical location of the vehicle, determining a value of user distraction level for a user in the vehicle based on the traffic pattern, and changing presentation of user experience to the user based on the value of the user distraction level. In one implementation, determining the value of the user distraction level based on the traffic pattern encountered by the vehicle further comprises determining the value of the user distraction level based on latency of the vehicle to a destination.

In another implementation, the vehicle is a semi-autonomous vehicle and determining the user distraction level for the user further comprises determining an amount of active driving of the semi-autonomous vehicle required of the user. Alternatively, determining an amount of active driving of the semi-autonomous vehicle required of the user further comprises determining the amount of active driving of the semi-autonomous vehicle required of the user based on projected traffic patterns. In yet another implementation, determining the user distraction level for the user further comprises determining the user distraction level for the user based on one or more personal data graphs of the user. Alternatively, determining the user distraction level for the user further comprises determining number of stops for the user during the user's commute before the user is to reach a final destination and to update the user distraction level based on the number of stops for the user.

In another implementation, changing presentation of user experience further comprises changing the presentation of user experience based on change in total time to destination for the user. Alternatively, changing presentation of user experience further comprises changing the presentation of user experience based on a change in emotional status of the user. In one implementation, the emotional status of the user is determined based on an output from a sensor in the vehicle.

A physical article of manufacture disclosed herein includes one or more tangible computer-readable storage media, encoding computer-executable instructions for executing on a computer system a computer process, the computer process including determining, using graphical positioning system (GPS) parameters, a geo-physical location of a vehicle, determining a value of user distraction level for a user in the vehicle, and changing presentation of user experience to the user based on the value of the user distraction level. In one implementation, the vehicle is a semi-autonomous vehicle and determining the user distraction level for the user further comprises determining an amount of active driving of the semi-autonomous vehicle required of the user. Alternatively, the computer process further includes determining the amount of active driving of the semi-autonomous vehicle required of the user based on projected traffic patterns.

In one implementation, the computer process further includes determining the user distraction level for the user based on one or more personal data graphs of the user. In an alternative implementation, the computer process further includes determining number of stops for the user during the user's commute before the user is to reach a final destination and to update the user distraction level based on the number of stops for the user. Yet alternatively, the computer process further includes changing the presentation of user experience based on level of importance of a task underlying the presentation of user experience.

A system for delivering personalized user experience includes a memory, one or more processor units, a GPS parameter processing module stored in the memory and executable by the one or more processor units, the GPS parameter processing module configured to analyze GPS parameters received from at least one of a vehicle to and a mobile device of a user in the semi-autonomous vehicle to determine a location of the vehicle, a distraction level determination module stored in the memory and executable by the one or more processor units, configured to determine value of user distraction level for the user in the vehicle, and a presentation module configured to change presentation of user experience to the user based on the value of the user distraction level.

In one implementation, the presentation module is further configured to compare the value of the user distraction level with a user distraction threshold and to change the presentation of user experience from a productivity-based presentation of user experience to an entertainment-based presentation of user experience if the user distraction level is above the user distraction threshold. In another implementation, the presentation module is further configured to compare the value of the user distraction level with a user distraction threshold and to change the presentation of user experience from an entertainment-based presentation of user experience to a productivity-based presentation of user experience if the user distraction level is above the user distraction threshold.

In one implementation, the distraction level determination module is further configured to determine the value of the user distraction level based on traffic pattern encountered by the vehicle. In another implementation, the vehicle is a semi-autonomous vehicle and wherein the distraction level determination module is further configured to determine an amount of active driving of the semi-autonomous vehicle required of the user and to adjust the distraction level of the user based on the amount of active driving of the semi-autonomous vehicle required of the user.

The above specification, examples, and data provide a complete description of the structure and use of exemplary embodiments of the invention. Since many implementations of the invention can be made without departing from the spirit and scope of the invention, the invention resides in the claims hereinafter appended. Furthermore, structural features of the different embodiments may be combined in yet another implementation without departing from the recited claims.

What is claimed is:

1. A method of providing personalization in a driverless environment, comprising:
determining, using graphical positioning system (GPS) parameters, a geo-physical location of a vehicle;
determining a traffic pattern encountered by the vehicle based on the geo-physical location of the vehicle;
determining a value of user distraction level for a user in the vehicle based on the traffic pattern; and
changing presentation of user experience to the user based on the value of the user distraction level.

2. The method of claim 1, wherein determining the value of the user distraction level based on the traffic pattern encountered by the vehicle further comprises determining the value of the user distraction level based on latency of the vehicle to a destination.

3. The method of claim 1, wherein the vehicle is a semi-autonomous vehicle and determining the user distraction level for the user further comprises determining an amount of active driving of the semi-autonomous vehicle required of the user.

4. The method of claim 3, wherein determining an amount of active driving of the semi-autonomous vehicle required of the user further comprises determining the amount of active driving of the semi-autonomous vehicle required of the user based on projected traffic patterns.

5. The method of claim 1, wherein determining the user distraction level for the user further comprises determining the user distraction level for the user based on one or more personal data graphs of the user.

6. The method of claim 1, wherein determining the user distraction level for the user further comprises determining number of stops for the user during the user's commute before the user is to reach a final destination and to update the user distraction level based on the number of stops for the user.

7. The method of claim 1, wherein changing presentation of user experience further comprises changing the presentation of user experience based on change in total time to destination for the user.

8. The method of claim 1, wherein changing presentation of user experience further comprises changing the presentation of user experience based on a change in emotional status of the user.

9. The method of claim 8, wherein the emotional status of the user is determined based on an output from a sensor in the vehicle.

10. A physical article of manufacture including one or more tangible computer-readable storage media, encoding computer-executable instructions for executing on a computer system a computer process, the computer process comprising:
determining, using graphical positioning system (GPS) parameters, a geo-physical location of a vehicle;
determining a value of user distraction level for a user in the vehicle; and
changing presentation of user experience to the user based on the value of the user distraction level.

11. The physical article of manufacture of claim 10, wherein the vehicle is a semi-autonomous vehicle and determining the user distraction level for the user further comprises determining an amount of active driving of the semi-autonomous vehicle required of the user.

12. The physical article of manufacture of claim 10, wherein the computer process further comprising determining the amount of active driving of the semi-autonomous vehicle required of the user based on projected traffic patterns.

13. The physical article of manufacture of claim 10, wherein the computer process further comprising determining the user distraction level for the user based on one or more personal data graphs of the user.

14. The physical article of manufacture of claim 10, wherein the computer process further comprising determining number of stops for the user during the user's commute before the user is to reach a final destination and to update the user distraction level based on the number of stops for the user.

15. The physical article of manufacture of claim 10, wherein the computer process further comprising changing the presentation of user experience based on level of importance of a task underlying the presentation of user experience.

16. A system for delivering personalized user experience, comprising:
memory;
one or more processor units;
a GPS parameter processing module stored in the memory and executable by the one or more processor units, the GPS parameter processing module configured to analyze GPS parameters received from at least one of a vehicle to and a mobile device of a user in the semi-autonomous vehicle to determine a location of the vehicle;
a distraction level determination module stored in the memory and executable by the one or more processor units, configured to determine value of user distraction level for the user in the vehicle; and
a presentation module configured to change presentation of user experience to the user based on the value of the user distraction level.

17. The system of claim 16, wherein the presentation module is further configured to compare the value of the user distraction level with a user distraction threshold and to change the presentation of user experience from a productivity-based presentation of user experience to an entertainment-based presentation of user experience if the user distraction level is above the user distraction threshold.

18. The system of claim 16, wherein the presentation module is further configured to compare the value of the user distraction level with a user distraction threshold and to change the presentation of user experience from an entertainment-based presentation of user experience to a productivity-based presentation of user experience if the user distraction level is above the user distraction threshold.

19. The system of claim 16, wherein the distraction level determination module is further configured to determine the value of the user distraction level based on traffic pattern encountered by the vehicle.

20. The system of claim 19, wherein the vehicle is a semi-autonomous vehicle and wherein the distraction level determination module is further configured to determine an amount of active driving of the semi-autonomous vehicle required of the user and to adjust the distraction level of the user based on the amount of active driving of the semi-autonomous vehicle required of the user.
